(19) United States
(12) Patent Application Publication
(10) Pub. No.: US 2025/0357751 A1
(43) Pub. Date: Nov. 20, 2025

(54) LIMITING DISTANCE ELEMENTS OVERREACH FOR INCOMING POWER FLOW

(71) Applicant: Schweitzer Engineering Laboratories, Inc., Pullman, WA (US)

(72) Inventors: Kanchanrao Gangadhar Dase, Pullman, WA (US); Armando Guzman-Casillas, Pullman, WA (US)

(73) Assignee: Schweitzer Engineering Laboratories, Inc., Pullman, WA (US)

(21) Appl. No.: 19/212,303

(22) Filed: May 19, 2025

Related U.S. Application Data
(60) Provisional application No. 63/649,658, filed on May 20, 2024.

(51) Int. Cl. H02H 7/22; H02H 1/00

(52) U.S. Cl. CPC H02H 7/226; H02H 1/0007

(57) ABSTRACT

Distance protection for electric power delivery systems using distance elements with characteristics that prevent distance element overreach. The distance protection systems and methods herein may be used in systems that experience incoming power flow with enhanced security. Improved mho and quadrilateral elements are described that may have observation windows longer or shorter than half a cycle of transmission line signals. Such mho and quadrilateral elements may determine fault conditions, such as resistive faults, with improved reliability and efficiency.

### CROSS REFERENCE TO RELATED APPLICATIONS

This application claims benefit of U.S. Provisional Patent Application No. 63/649,658, filed on May 20, 2024, and herein incorporated by reference in its entirety.

### BACKGROUND

This disclosure relates to distance protection for electric power delivery systems. A distance protection element may generate a characteristic or representation of a protected zone of an electric power delivery system. The distance protection element may monitor and secure the protected zone using the generated characteristic. In some cases, the characteristic may represent the protected zone with undesirably changed boundaries. Such undesired changes to the boundaries of the protected zone may result in reduced security of the electric power delivery system. For example, the distance protection element may misoperate based on the changed boundaries. This disclosure relates to securing distance protection elements to address misoperations during incoming power flow.

### BRIEF DESCRIPTION OF THE DRAWINGS

Various aspects of this disclosure may be better understood upon reading the following detailed description and upon reference to the drawings described below in which like numerals refer to like parts.

FIG. 1 illustrates a one-line diagram of an electrical power delivery system comprising intelligent electronic devices (IEDs) implementing distance protection, in accordance with several embodiments;

FIGS. 2A and 2B illustrate currents and voltages collected from the electric power delivery system of FIG. 1 during an event or disturbance, in accordance with embodiments of the present disclosure;

FIG. 3 illustrates an expanded mho characteristic in a forward direction on an impedance plane with corrected boundaries, in accordance with several embodiments;

FIG. 4 illustrates a quadrilateral characteristic boundary in a forward direction on an impedance plane with corrected boundaries, in accordance with several embodiments; and

FIG. 5 is a process flow diagram for generating a characteristic and adjusting boundaries of the characteristic to reduce at least a portion of deviations of a boundary of the characteristic, in accordance with embodiments of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

An electric power delivery system may include electric power sources (e.g., electric power generators) and loads coupled via transmission lines (e.g., conductors). The electric power sources may include synchronous and/or asynchronous electric power generators and/or electric power sources. Asynchronous electric power sources may include wind-powered induction sources, inverter-based sources such as wind-powered sources and/or photovoltaic-powered sources, among other possibilities.

The electric power delivery system may include one or more intelligent electronic devices (IEDs) and relays coupled to a transmission line. An IED may obtain electrical measurements from the transmission line to monitor and protect the electric power delivery system. For example, an IED may determine a fault condition of the electric power delivery system based on measuring voltage and current of the transmission line. A fault condition may be caused or triggered by an undesired change in a frequency, a voltage, and/or a current of a signal of the transmission line, among other possibilities. For example, a fault condition may be indicative of an undesired short circuit of the transmission line. In some cases, the IED may respond to the determined fault condition by performing a protective action such as tripping a relay (e.g., a circuit breaker, a breaker).

The IED may implement and run one or more distance protection elements to determine the fault condition. A distance protection element may receive signals from the transmission line during a normal operation and fault condition. During the normal condition, the distance protection element may filter a voltage and/or a current of the received signals to generate one or more characteristics on an impedance plane. Each characteristic may indicate boundaries of a protected zone of the transmission line on the impedance plane. The protected zone may correspond to a length of the transmission line being monitored. The protected length of the transmission line may be between a point of coupling of (e.g., observation of) the IED and/or a relay to the transmission line and a threshold distance along the transmission line from the coupling point in a forward or a reverse direction. For example, different characteristics may have different boundaries associated with different protected zones.

The distance protection element may filter a voltage and/or a current of subsequently received signals to determine whether a disturbance occurs. The disturbance may correspond to a deviation of the voltage, the current, and/or a frequency of the received signals from an expected pattern beyond a threshold. In response to a disturbance, the distance protection element may determine whether the voltage and current of the signal associated with the disturbance falls within the protected zone of the relay. The distance protection element may determine an impedance of the transmission line based on the voltage and current of the signal associated with the disturbance, and plot the determined impedance as an operating point on the impedance plane.

In some embodiments, the IED may trip the relay in response to the disturbance being within the protected zone when the operating point determined by a distance element is within the boundaries of the characteristic. Moreover, the IED may not trip the breaker in response to the disturbance being outside the protected zone when the operating point is outside the characteristic. For example, the relay is associated with protecting the length of the transmission line being monitored and one or more load coupled to the monitored portion (or length) of the transmission line. It should be appreciated that tripping the breaker is provided as an example, and the IED may perform any additional or other protective actions.

If not compensated for, in some cases, one or more electric power sources may generate and/or provide the electric power with unexpected and/or undesired voltage and/or current values. For example, the electricity (e.g., the electric power) being delivered may have unexpected and/or undesired transients and/or load flow variations causing undesired changes of voltages, currents, and/or frequencies of the signals. If not compensated for, these readings (e.g., undesired changes to the readings) may adversely affect (e.g., compromise) the operation of the distance protection elements. In the embodiments discussed herein, the distance protection elements may generate the characteristics on the impedance plane by compensating for adverse effects of these readings.

As mentioned above, during normal conditions, the distance protection element may filter a voltage and/or a current of the received signals to generate one or more characteristics on an impedance plane. Each characteristic may correspond to or include a representation of boundaries of a protected zone of the transmission line on the impedance plane. The boundaries of each protected zone represented by a characteristic may correspond to lengths of one or more phases of the transmission lines being monitored, protected, or secured by the distance protection element. The distance protection element may map a value (e.g., a determined impedance value) associated with each determined disturbance of the transmission line to a respective point in each of the generated characteristics. The distance protection element may determine whether each disturbance falls within the boundaries of one or more of the protected zones. The distance protection element may perform one or more protective actions for each protected zone including the disturbance.

For example, unexpected and/or undesired transients and/or load flow variations may adversely affect (e.g., compromise) the operation of the distance protection elements. If not compensated for, the distance protection elements may generate a characteristic of a protected zone with changed (e.g., expanded) boundaries on the impedance plane. Such changed (e.g., expanded) boundaries may result in erroneously identifying a disturbance outside the protection zone within the protection zone. Moreover, if not compensated for, the IED may perform a protective action with respect to the protected zone. For example, the IED may trip the relay halting an electric power delivery to the loads being fed by the transmission line while the disturbance is outside the protected zone.

In the embodiments discussed herein, the distance protection elements may perform countermeasures to reduce a change (e.g., expansion) of the boundaries of the characteristics. In some embodiments, the distance protection elements may project the pole onto an extension of the line impedance to at least partially reduce undesired shifts and/or expansions of the boundaries of the mho characteristic. In alternative or additional embodiments, the distance protection elements may determine an adaptive angle to compensate an undesired counterclockwise tilt of a top reactance element or a quadrilateral characteristic boundary, and thereby at least partially reduce undesired shifts and/or expansions of the boundaries of the quadrilateral characteristic. Accordingly, the IED may have improved reliability and reduced error rate for detecting fault conditions of one or more protected zones and/or performing a protective action such as tripping a breaker compared to other IEDs.

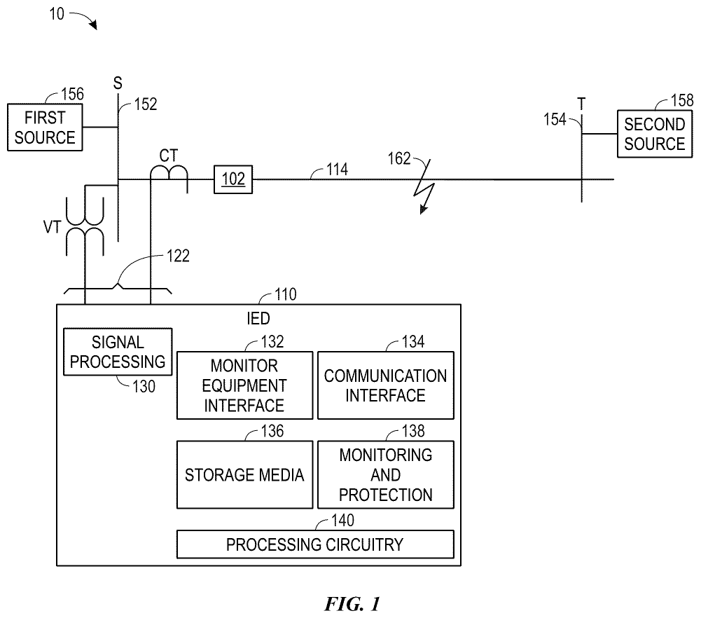

FIG. 1 illustrates at least a portion of an electric power delivery system 10, according to embodiments of the current disclosure. The electric power delivery system 10 may include a first source 156 (e.g., a first electric power source) at a first terminal 152 (e.g., a terminal S) local to an IED 110 (e.g., a distance protection relay) and a second source 158 (e.g., a second electric power source) at second terminal 154 (e.g., a terminal T) that is remote to the IED 110. A transmission line 114 may couple the first terminal 152 with the second terminal 154.

The sources 156 and/or 158 may each include a synchronous and/or an asynchronous source. An asynchronous source may include wind-powered induction sources, inverter-based sources such as wind-powered sources and/or photovoltaic-powered sources, among other possibilities. The electric power delivery system 10 may include various other transmission lines, branches, transformers, loads, and the like. For example, the electric power delivery system 10 may be illustrated in simplified form for ease of discussion herein. The transmission line 114 may be monitored and protected using the IED 110 and one or more other IEDs (not illustrated).

The IED 110 provides protection such as differential protection, distance protection, overcurrent protection, and the like. The IED 110 may include processing circuitry 140 for executing computer instructions, which may comprise one or more general purpose processors, special purposes processors, application-specific integrated circuits, programmable logic elements such as field programmable gate arrays, or the like. The IED 110 may further comprise non-transitory machine-readable storage media 136, which may include one or more disks, solid-state storage (e.g., Flash memory), optical media, or the like for storing computer instructions, measurements, settings and the like. In various embodiments the storage media 136 may be packaged with the processing circuitry 140, separate from the processing circuitry 140, or there may be multiple physical storage media 136 including media packaged with the processing circuitry 140 and media 136 separate from the processing circuitry 140.

The IED 110 may be communicatively coupled to other IEDs and/or supervisory systems either directly or using one or more communication networks via one or more communication interfaces 134. For example, the IED 110 may be communicatively coupled to a circuit breaker 102. In some embodiments, the IED 110 may include human-machine interface (HMI) components (not shown), such as a display, input devices, and so on.

The IED 110 may receive signals 122, or one or more indications thereof, indicative a voltage, a current, and/or a frequency of the electric power being delivered by the first source 156. For example, the received signals 122 are indicative of electrical power delivered to one or more loads of the electric power delivery system 10 coupled to the transmission line 114 between the terminals 152 and 154. The IED 110 may have a point of coupling or point of observation (e.g., a first location) of the electric power being delivered by the first source 156 on the transmission line 114.

In some embodiments, the IED 110 may include a signal processing module 130 (e.g., a data acquisition subsystem) and current sensor and/or voltage sensors coupled to the transmission line 114 to receive and process the received signals 122. Line currents and voltages are sampled at a rate suitable for protection, such as in the order of kilohertz to megahertz. For example, the IED 110 (e.g., the signal processing module 130) may filter the voltage and/or current of the received signals 122, for example, at high speed, among other conditions. The high speed filtering may correspond to using an observation window of less than a threshold number (e.g., 1, 2, 3, and so on) of wavelengths or a portion of a single wavelength of the received signals 122 such as a quadrature-cycle of the received signal or less, a half-cycle observation window of the received signal or less, among other possibilities. An analog-to-digital converter (ADC) may be included to create digital representations of the incoming line current and voltage measurements. The output of the ADC may be used in various embodiments herein. As described above, the voltage and/or current of the received signals 122 are used to detect fault conditions (e.g., a fault condition 162) and determine (or trigger) a protective action.

For example, the IED 110 may obtain the received signals 122 (e.g., electrical signals, stimulus signals) from the electric power delivery system 10 through instrument transformers (CTs, VTs, or the like). The received signals 122 may be received directly via the measurement devices described above and/or indirectly via the communication interface 134 (e.g., from another IED or other monitoring device (not shown) in the electric power delivery system 10). The received signals 122 may include, but is not limited to: current measurements, voltage measurements, equipment status (breaker open/closed) and the like.

The IED 110 may include a monitoring and protection module 138 including and/or implementing one or more distance protection elements (e.g., mho distance elements, quadrilateral distance elements). In some embodiments, the distance protection elements may include or be defined by instructions stored on a computer-readable media such as a storage media 136. The instructions, when executed by the processing circuitry 140, may cause the IED 110 to detect a fault condition 162 and may also cause the IED 110 to execute a protective action in response to the detected fault condition 162.

The IED 110 may run or implement one or more distance protection elements such as a mho distance protection element, referred to hereinafter as the mho element, and/or a quadrilateral distance protection element, referred to hereinafter as the quadrilateral element, by the processing circuitry 140. A distance protection element of the IED 110 may determine whether a fault condition 162 occurs on one or more protected zones of the transmission line 114 by running one or more distance protection elements using the received signals 122. For example, the distance protection element may determine fault conditions (e.g., the fault condition 162) by corresponding an impedance, a voltage, and/or a current of the received signals 122 to an impedance plane.

A protected zone of the transmission line 114 may correspond to a portion (e.g., a length) of the transmission line 114 between the point of coupling or observation of the IED 110 and an end point or a threshold distance farther along the transmission line 114. The protection zone may be defined in a forward or a reverse direction. The distance protection element may generate one or more characteristics based on currents, voltages, and/or impedances of the received signals 122 before and during (or after) the disturbance associated with the fault condition 162. The one or more characteristics may include a mho characteristic, a quadrilateral characteristic, or both. The protected zone may be defined by each mho characteristic and/or quadrilateral characteristic in a forward direction or a reverse direction along the transmission line. Moreover, the distance protection element may determine and/or indicate an occurrence of a fault condition (e.g., the fault condition 162) in response to the operating values of the received signal corresponding to an operating point on the impedance plane within the boundaries of the characteristic on the impedance plane.

An example of mho characteristics and/or mho elements may be described by U.S. Pat. No. 5,325,061, “Computationally Efficient Distance Relay for Power Transmission Lines,” which is assigned to Schweitzer Engineering Laboratories Inc and incorporated by reference herein in its entirety for all purposes. Moreover, an example of quadrilateral characteristics and/or quadrilateral elements (e.g., reactance element) may be described by U.S. Pat. No. 8,410,785, “Electrical Power System Phase and Ground Protection Using Adaptive Quadrilateral Characteristics,” which is assigned to Schweitzer Engineering Laboratories Inc and incorporated by reference herein in its entirety for all purposes. For example, undesired current and/or voltage disturbance of each of three phases A, B, and C of the transmission line 114 may adversely affect a faulted-loop determination and/or selection logic of a mho element and/or adversely affect a reactance comparator polarization of a quadrilateral element. A faulted-loop selection logic of a mho characteristic or a quadrilateral characteristic may correspond to a protected zone (e.g., the first protected zone, the second protected zone, etc.) of one or more phases A, B, and C of the transmission line 114.

In the depicted embodiment, the received signals 122 are being monitored at or received from a single end of the electric power delivery system 10 at or close to the first source 156 and/or the first terminal 152. Each protected zone may be associated with a portion of the transmission line 114 in forward direction from the first source 156 and/or the first terminal 152 toward the second terminal 154. Moreover, each protected zone may be associated with a reach line or reach point proportional to length of the transmission line 114 in reverse direction. The IED 110 may determine a fault location of the fault condition 162 and whether the operating point associated the fault condition and/or location is within one or more protected zones in response to detecting a disturbance based on the received signals 122. In some cases, the IED 110 may determine the fault location by using the first source 156 and/or the first terminal 152 as a reference.

As mentioned above, the storage media 136 may store instructions indicative of one or more protective action. As such, the IED 110 may retrieve such instructions to generate control signals indicative of such protective actions in response to determining occurrence of the fault condition 162. In one example, the protective action may include opening or tripping a circuit breaker (e.g., the circuit breaker 102) to reduce or halt delivery of the electrical power to the loads of the protected zone that the transmission line 114 feeds. As such, the IED 110 may provide one or more control signals to open or trip the circuit breaker 102 on one or more appropriate phases via the monitored equipment interface 132 upon detection of the fault condition 162. Alternatively or additionally, the IED 110 may display information related to the fault condition 162, send messages including the information of the fault condition 162, and the like. Methods disclosed herein may generally follow the instructions stored on a storage (e.g., the storage media 136) for protection of the electric power delivery system 10.

A monitored equipment interface 132 may be in electrical communication with one or more monitored equipment such as the circuit breaker 102. The monitored equipment interface 132 may include hardware for providing one or more control signals to the circuit breaker 102 to open and/or close in response to a command from the monitoring and protection module 138. For example, upon detection of the fault condition 162 and determining that the fault condition 162 is within a zone of protection, the monitoring and protection module 138 may determine a protective action and effect the protective action on the electric power delivery system 10 by, for example, signaling the monitored equipment interface 132 to provide an open control signal to the appropriate circuit breaker 102.

Upon detection of the fault condition 162 and determination that the fault condition 162 is within the protected zone, the IED 110 may signal other devices (using, for example, the network, or signaling another device directly by using inputs and outputs) regarding the fault condition 162, which other devices may signal a breaker to open, thus effecting the protective action on the electric power delivery system 10. The protective actions may include communication-assisted protection actions. For example, the IED 110 after detecting the fault to be in the protected zone, may signal a second IED at the remote end of the transmission line 114, coupled to and/or near the second source 158 and/or the second terminal 154, to trip one or more respective breakers and isolate the determined fault from the local terminal (e.g., the first source 156 and/or the first terminal 152) and the remote terminal (e.g., the second source 158 and/or the second terminal 154).

With the foregoing in mind, the IED 110 may detect fault conditions, such as the fault condition 162, on the electric power delivery system 10, determine if the fault condition 162 is within a protected zone, and effect a protective action if the fault condition 162 is within the protected zone. Accordingly, the IED 110 may include distance protection elements to determine a fault condition 162, determine if the fault condition 162 is internal to the protected zone, and send a trip control signal to circuit breaker 102. The distance protection element may include several components, including directional determination, faulted loop determination, and distance determination. The distance protection element in accordance with several embodiments herein may retain integrity even when used to protect the electric power delivery system 10 with the first source 156.

Although operations are described herein as being performed by the IED 110, it should be appreciated that alternatively or additionally, one or more components of the IED 110 or any other viable circuitry may perform all or at least a portion of the operations. For example, the processing circuitry 140, the signal processing 130, the monitoring and protection circuitry 138, the monitored equipment interface 132, the communication interface 134, and/or the storage media 136 may each perform all or at least a portion of the operations discussed. In some cases, the processing circuitry 140 and the IED 110 may be interchangeably used such that the processing circuitry 140 may include the IED 110 or at least a portion of the IED 110.

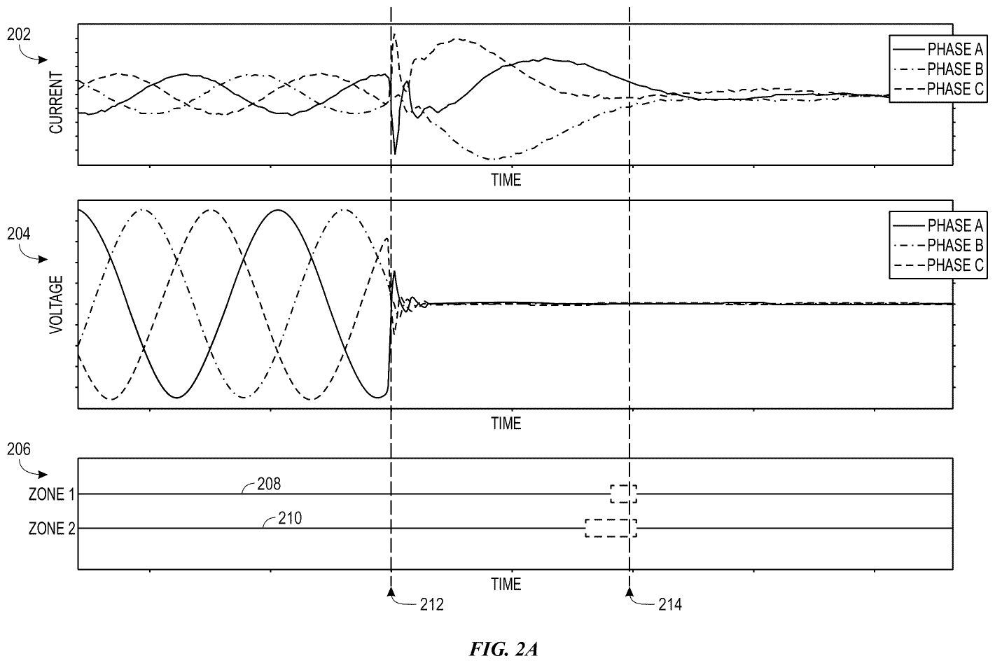

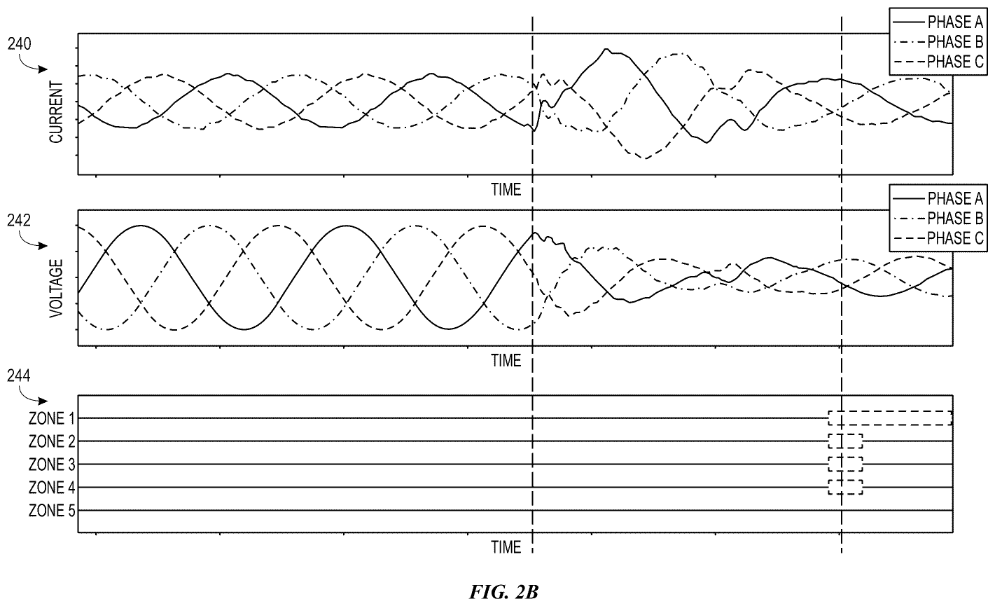

FIG. 2A illustrates a current plot 202, a voltage plot 204, and a distance protection element pickup plot 206 during a 3-phase fault condition (e.g., the fault condition 162) that may appear beyond (e.g., over, extended farther than) the remote terminal of the transmission line 114, according to embodiments of the current disclosure. The IED 110 may receive voltage, current, and/or frequency values of the received signals 122 discussed above associated with the electric power being delivered to the loads of the electric power delivery system 10 by the transmission line 114. The IED 110 may receive an indication of currents of phases A, B, and C illustrated in the current plot 202. Moreover, the IED 110 may receive an indication of voltages of the phases A, B, and C illustrated in the voltage plot 204.

The first source 156 may output the currents and the voltages of the phases A, B, and C to the loads of the electric power delivery system 10 during a normal operation and/or before the first time 212 when the 3-phase fault condition occurs. For example, the IED 110 may receive the indication of currents and voltages of the phases A, B, and C based on the received signals 122. Moreover, although the fault is at the fault condition 162 on the transmission line 114, the 3-phase fault condition may undesirably correspond to a fault location that is located farther than and/or beyond the remote terminal of the transmission line 114.

One or more distance protection elements of the IED 110 may generate a first characteristic for a first protected zone (e.g., zone 1) and a second characteristic for a second protected zone (e.g., zone 2). The one or more distance protection elements may include a mho element or a quadrilateral element. The first characteristic may include a mho characteristic or a quadrilateral characteristic. Similarly, the second characteristic may include a mho characteristic or a quadrilateral characteristic. The IED 110 may generate the first characteristic and the second characteristic on an impedance plane based on the currents and the voltages of the phases A, B, and C during the normal operation of the electric power delivery system 10 before the first time 212. The IED 110 may determine whether one or more fault conditions (e.g., the fault condition 162) are within the respective protected zones of the first characteristic and/or the second characteristic.

The first protected zone may correspond to a first portion of one or more of the phases A, B, and/or C between the point of coupling or observation of the IED 110 and a first end point or a first threshold distance farther along the transmission line 114. Moreover, the second protected zone may correspond to a second portion of one or more of the phases A, B, and/or C between the point of coupling or observation of the IED 110 and a second end point or a second threshold distance farther and beyond the second terminal 154 on the transmission line 114. The first characteristic and the second characteristic may each have boundaries corresponding to the respective portions or lengths of the transmission line 114 being monitored. The IED 110 may generate (e.g., assert) a first fault signal 208 in response to detecting a fault condition within the boundaries of the first protected zone. Moreover, the IED 110 may generate a second fault signal 210 in response to detecting a fault condition within the boundaries of the second protected zone.

In some cases, the IED 110 may receive unexpected and/or undesired transients and/or load flow variations with the electric power being delivered by the transmission line 114 to the loads of the electric power delivery system 10 during the normal operation and/or during the fault condition (e.g. 3-phase fault condition initiated at the first time 212). As such, if not compensated for, the IED 110 may receive and/or determine erroneous readings of the currents, the voltages, and/or a frequency of the phases A, B, and C of the electric power being delivered to the loads that may adversely affect (e.g., compromise) operation of the distance protection. By way of example, the IED 110 may determine the 3-phase fault condition that is beyond or farther than the fault location 162 and/or beyond the second terminal 154 (e.g., the remote terminal 154) of the transmission line 114 to be within the first protected zone at a second time 214 (e.g., instead of the first time 212) based on such undesired readings.

If not compensated for, the IED 110 may undesirably determine a location of the fault condition beyond the remote terminal 154 of the transmission line 114 to be within the first protected zone. For example, if not compensated for, the IED 110 may generate the first characteristic and/or the second characteristic with undesirably changed (e.g., expanded) boundaries. Moreover, in some cases, the IED 110 may determine a location of the fault condition occurred or being occurred outside the first protected zone and/or the second protected zone within the first protected zone and/or the second protected zone. That is, if not compensated for, the IED 110 may undesirably overreach outside the boundaries of the first characteristic and/or the second characteristic. As such, the IED 110 may at least partially compensate for the undesired changes, deviations, and/or expansion of the boundaries of the first characteristic and/or the second characteristic. In some cases, transients and/or load flow changes on the transmission line 114 during the fault may cause such undesired changes. Accordingly, the IED 110 may determine a location of the fault condition along the transmission line 114 without or with reduced rate or occurrence of undesirable boundary changes.

In the depicted embodiment, the 3-phase fault condition disturbed a current and a voltage of all three phases A, B, and C of the transmission line 114 at the first time 212. A current and/or voltage disturbance may correspond to a change in the current, the voltage, and/or the frequency of each of the three phases A, B, and C higher than a threshold value. For example, the IED 110 may determine the disturbance based on a current, voltage, and/or frequency of one or more of the phases A, B, and C deviating from an expected value higher than a deviation threshold at or near the first time 212. The IED 110 may determine the expected value based on the received signals 122, such as the current illustrated in the current plot 202 and/or the voltage illustrated in the voltage plot 204, during the normal operation of the first source 156 and/or the electric power delivery system 10. It should be appreciated that the threshold value and/or the deviation threshold may be different in different embodiments.

For example, the location of the 3-phase fault condition does not fall within the first protected zone and/or the second protected zone. If not compensated for, the IED 110 may determine a location of the 3-phase fault condition within the first protected zone and/or the second protected zone based on the second time 214. As such, the IED 110 may at least partially compensate for the undesired changes, deviations, and/or expansions of the boundary of the first characteristic and/or the second characteristic. Accordingly, the IED 110 may determine a location of the 3-phase fault condition outside of the first protected zone and/or the second protected zone.

That is, in some cases, the IED 110 may not overreach beyond the boundaries of the first characteristic and/or the second characteristic. Moreover, the IED 110 may not erroneously trigger one or more protective actions with respect to the first protected zone and/or the second protected zone when the 3-phase fault condition is outside the first protected zone and/or the second protected zone. Accordingly, the IED 110 may detect whether a fault condition falls within a protected zone or a loop including the protected zone and one or more of the phases A, B, and C with reduced error rate. Moreover, the IED 110 may perform protective actions for each protected zone or loop with reduced error rates based on the improved fault condition detection.

FIG. 2B illustrates a current plot 240, a voltage plot 242, and a distance protection element pickup plot 244 during a 3-phase fault that occurred several buses (e.g., transmission lines) away from the monitored and protected transmission line 114, according to embodiments of the current disclosure. Similar to the event illustrated in FIG. 2A, the IED 110 may reduce an undesired expansion of one or more mho characteristics and/or counterclockwise tilts in first quadrant of one or more quadrilateral characteristic. It has been observed that the element (e.g., a high speed element, a mho element, a quadrilateral element) picks up momentarily because of the second transients in the faulted phase voltages and/or currents. That is, the IED 110 may reduce occurrence of overreaching beyond the boundaries of characteristics associated with one or more protected zone. Moreover, the IED 110 may reduce occurrence of erroneously triggering one or more protective actions with respect to the protected zones when the 3-phase fault condition is outside the protected zones. Accordingly, the IED 110 may detect whether a fault condition falls within a protected zone or a loop with reduced error rate. Moreover, the IED 110 may perform protective actions for each protected zone or loop with reduced error rates based on the improved fault condition detection.

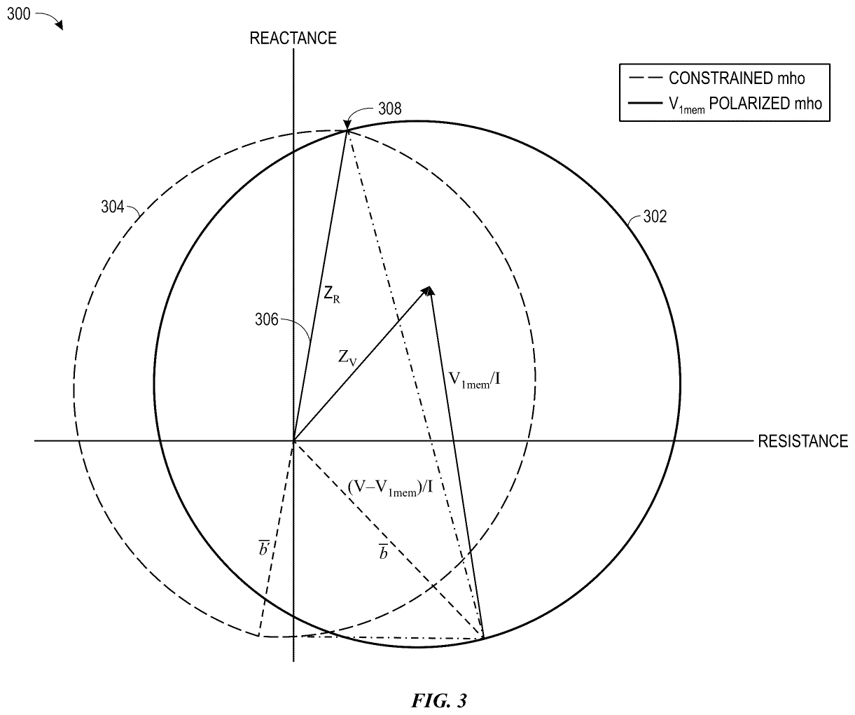

FIG. 3 illustrates a mho characteristic 302 (e.g., an expanded mho characteristic) in a forward direction on an impedance plane 300, according to embodiments of the current disclosure. The IED 110 may include a mho element that may generate the mho characteristic 302 with a circular shape defined by a forward direction reach line 306 or Z_{R} (e.g., a positive sequence reach impedance). The IED 110 may measure the loop current (I) and reach impedance (Z_{R}) or apparent impedance (Z_{V}) before and/or a disturbance. In the depicted embodiment, the forward direction reach line 306 may correspond to a positive sequence reach impedance. It should be appreciated that in alternative or additional embodiments, the forward direction reach line 306 is applicable for forward and reverse faults.

The forward direction reach line 306 may correspond to a straight line on the impedance plane 300 starting at the center of the impedance plane 300 and ending at the reach point 308. The center of the impedance plane 300 may represent a zero impedance at the point of coupling of the IED 110 to the transmission line 114. The reach point 308 of the forward direction reach line 306 on the impedance plane 300 may represent a measured impedance (e.g., an impedance point, reach impedance, the reach point) of the protected zone of the mho characteristic 302, for example, based on measuring a positive sequence memory voltage associated with the protected zone of the transmission line 114.

In some embodiments, the IED 110 may determine and/or measure the impedance of the protected zone and/or determine the reach point 308 of the forward direction reach line 306 and/or the forward direction reach line 306 during a normal operation of the electric power delivery system 10. In the depicted embodiment, the circular shape may correspond to boundaries of a protected zone (e.g., the first protected zone, the second protected zone, and so on) being monitored and/or protected by the mho characteristic 302. That is, the mho characteristic 302 may illustrate a reach or boundary of a protected zone. It should be appreciated that in alternative or additional embodiments, the IED 110 may generate the mho characteristic 302 with any other viable shape such as an constrained (lenticular) or expanded (tomato) characteristics. The IED 110 (e.g., the mho element) may determine the mho characteristic 302 based on equation 1:

$$Real [ ( {IZ}_{R} - V ) \cdot conj ( {V}_{1 MEM} ) ] > 0 \qquad Eq . 1$$

In equation 1, I represents phase loop current or loop current, Z_{R} represents the reach impedance, V represents faulted phase voltage, and V₁ₘₑₘ represents the positive sequence memory voltage. The IED 110 may define the mho characteristic 302 using equation 1. The mho characteristic 302 may be polarized based on the positive sequence memory voltage (e.g., V₁ₘₑₘ). For example, the IED 110 may determine and/or measure the loop current, the reach impedance, and/or the positive sequence memory voltage before a disturbance. Moreover, the IED 110 may determine and/or measure the faulted phase voltage in response to (e.g., during, after) a disturbance. It should be appreciated that although a memory voltage with positive polarization is shown in FIG. 3 based on the fault condition 162 being in forward direction, a mho characteristic may still have positive sequence memory voltages in other cases, for example, when the fault condition 162 may be in reverse fault direction.

The IED 110 may use the positive sequence memory voltage (V₁ₘₑₘ) as a polarizing quantity to determine the pole b (e.g., a first impedance pole) and thereby expand the mho characteristic 302. The positive sequence memory voltage may provide a expansion of the characteristics and thereby may be used as the polarizing voltage. As mentioned above, for example, the IED 110 may determine the disturbance based on a current, voltage, and/or frequency of one or more of the phases A, B, and C of the transmission line 114 deviating from an expected value higher than a deviation threshold at or near the first time 212.

In some cases, the disturbance may undesirably change the positive sequence memory voltage, thereby undesirably change and/or expand a boundary of the mho characteristic 302. The IED 110 may shift or tilt the mho characteristic 302 clockwise or counterclockwise based on a direction of the power flow during a fault condition (e.g., the fault condition 162) to compensate for the undesired changes, deviations, and/or expansions of the mho characteristic 302. As such, the IED 110 may generate an expanded lenticular mho characteristic 304.

For example, for a forward fault condition (e.g., the fault condition 162), the mho characteristic 302 may undesirably tilt in counterclockwise direction while the power flow direction is incoming or reverse. In some cases, if not compensated for, a transient and spurious tilt similar to such counterclockwise tilt may cause undesired overreach. In some cases the first source 156 and/or the second source 158 discussed above may generate the received signals 122 with such transients and/or undesired power flow direction (e.g., incoming power flow, reverse power flow). As such, the IED 110 may generate the lenticular mho characteristic 304 by shifting or tilting (e.g., in clockwise direction) the mho characteristic 302. In the depicted embodiment, the IED 110 may generate the lenticular mho characteristic 304 (e.g., a corrected mho characteristic, adjusted mho characteristic) by projecting the pole b̅ onto a corrected pole b̅′ onto an extension of the forward direction reach line 306 of the impedance plane 300. The lenticular mho characteristic 304 may be polarized based on the corrected V_{POL}_{_{NEW}} (e.g., V−V₁ₘₑₘ). The IED 110 (e.g., the mho element) may determine the lenticular mho characteristic 304 based on equation 2:

$$Real [ ( {IZ}_{R} - V ) \cdot conj ( {V}_{{POL}_{NEW}} ) ] > 0 \qquad Eq . 2$$

The corrected pole b̅′ may correspond to a projection of the pole b onto an extension of the forward direction reach line 306. The extension of the forward direction reach line 306, and thereby the corrected pole b̅′, may be aligned with a positive sequence line impedance angle (e.g., Z_{1ANG}) between the forward direction reach line 306 and the resistance and/or reactance lines (e.g., axes) of the impedance plane 300. Although the extension of the forward direction reach line 306 is shown reverse direction, it should be appreciated that in additional or other cases, the extension may be in forward direction of the forward direction reach line 306. The characteristic angle may correspond to a in equation 4 below. Moreover, the IED 110 (e.g., the mho element) may determine the corrected pole b̅′ on an extension of the forward direction reach line 306 of the impedance plane 300 based on equation 3:

$${V}_{{POL}_{NEW}} = V + imag ( V - {V}_{1 mem} ) \cdot {e}^{j ( Z 1 ANG + ∠ I )} \qquad Eq . 3$$

Z_{1ANG} may correspond to the line impedance angle. To improve boundaries of the lenticular mho characteristic 304 and/or reduce undesired changes or expansions of the mho characteristic 302 Moreover, the IED 110 may generate the constrained (lenticular) mho characteristic 304 and/or convert the mho characteristic 302 into the lenticular mho characteristic 304 based on equation 4:

$$Real [ ( {IZ}_{R} - V ) \cdot conj ( {V}_{{POL}_{NEW}} ) ] > cos ( α ) \cdot \vert {IZ}_{R} - V \vert \cdot \vert {V}_{{POL}_{NEW}} \vert \qquad Eq . 4$$

The term α is characteristic angle where 0°<a>90°. For example, in equation 4, the lenticular mho characteristic 304 is defined based on a characteristic angle of 75° (e.g., α=75°). However, it should be appreciated that in alternative or additional cases, the characteristic angle may be different.

The IED 110 may project a polarization point of the mho characteristic 302 to a line impedance extension to at least partially reduce undesired shifts and/or expansions of the boundaries of the mho characteristic 302. That is, the IED 110 may perform countermeasures by generating the lenticular mho characteristic 304 based on the mho characteristic 302. Accordingly, the IED 110 may have improved reliability and reduced error rate for detecting fault conditions of one or more protected zones and/or performing a protective action such as tripping a circuit breaker compared to other IEDs.

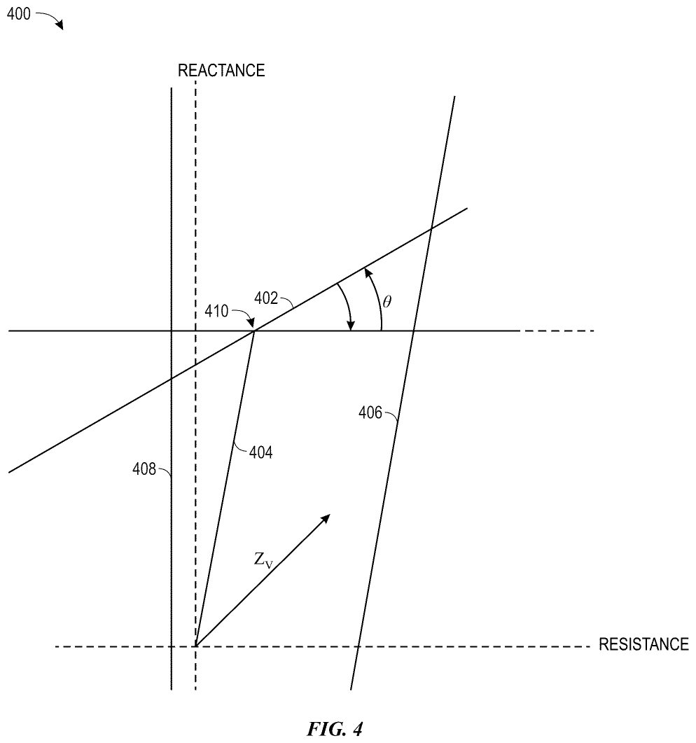

FIG. 4 illustrates a top reactance element or a quadrilateral characteristic boundary 402 (e.g., a boundary of a quadrilateral operating characteristic) of a quadrilateral characteristic or quadrilateral distance element in a forward direction on an impedance plane 400, according to embodiments of the current disclosure. The IED 110 may include and/or run a reactance element that may generate the quadrilateral characteristic boundary 402 covering forward faults based on a forward direction reach line 404. For example, the forward direction reach line 404 may correspond to a straight line on the impedance plane 400 starting at the center of the impedance plane 400 and ending at a reach point 410. The center of the impedance plane 400 may represent a zero impedance at the point of coupling of the IED 110 to the transmission line 114. The reach point 410 of the forward direction reach line 404 on the impedance plane 400 may represent a reach line impedance. For example, the forward direction reach line 404 may equal to Z_{R} (e.g., a proportion of positive sequence line impedance). The IED 110 may measure the loop current (I) and reach impedance (Z_{R}) before a disturbance.

The apparent-impedance operating characteristics may be modified as needed to account for various system attributes. For example, a fault resistance coverage may be controlled using settings for a resistive blinder 406 (e.g., a right-side blinder, a boundary) of the quadrilateral characteristic. For example, the resistive blinder 406 may be determined (e.g., predetermined) based on predetermined input settings of the quadrilateral element generating the quadrilateral characteristic. For example, the reliability of the quadrilateral characteristics can be enhanced by keeping the left resistance blinder, 408, close to the reactance axis. For example, the left resistive blinder 408 may be a constant (e.g., predetermined) proportional to the line impedance. In the depicted embodiment, the top reactance element or top boundary of the quadrilateral characteristic 402, the forward direction reach defined by the intersection of the line 402 (e.g., the top reactance element 402) and line 404 (e.g., the forward direction reach line), and the resistive blinders 406 and 408 may correspond to and/or define boundaries of a protected zone (e.g., the first protected zone, the second protected zone, and so on) being monitored and/or protected. That is, the reactance element 402 and the reach may illustrate a boundary of the protected zone.

The IED 110 may counter-balance (e.g., tilt down) undesired tilts of the reactance element characteristic 402 (e.g., a top side blinder) to reduce occurrence of (e.g., prevent) overreaching of the protected zone for fault conditions (e.g., the fault condition 162 with high fault resistance). The IED 110 may also tilt the reactance element characteristic 402 up in specific cases.

The resistive blinder 406 of the quadrilateral characteristic may be set based on an expected resistive (and/or reactive) load of the one or more monitored phases of the transmission line 114 associated with a loop or protected zone. The distance element operating characteristics used herein may be self-polarized in that they may use the loop voltage and current. The IED 110 may shape the reactance element characteristic 402 using a distance comparator convention. In alternative or additional embodiments, the IED 110 may derive an apparent impedance operating point (Z_{V}) and compare it (e.g., using basic geometry comparison) with the operating contour of the quadrilateral characteristic (e.g., the quadrilateral characteristic defined by the reactance element 402 and the resistive blinders 406 and 408) on the impedance plane 400. That is, when the apparent impedance value (Z_{V}) is within the operating characteristic, an internal fault is detected.

In certain applications, a reactance element characteristic 402 is preferred. Similar to the proposal for the mho element, the improvement of the reactance element, which is the top boundary of the quadrilateral characteristic, is to introduce an adaptive angle compensation to the reactance element characteristic 402 to limit the counterclockwise tilt. This compensation enhances the security of the quadrilateral element. Note, the compensation is not needed for the clockwise tilt. The counterclockwise and the clockwise rotations are defined by taking abscissa axis of the apparent impedance plane 400 as a reference. FIG. 4 illustrates the corrected quadrilateral characteristic with limitation on the counterclockwise tilt of the reactance element characteristic 402. The reactance element characteristic 402 may be described by equation 5:

$$x\_calc = \frac{imag [ V \cdot conj ( {I}_{Pol} \cdot {e}^{jTANG} \cdot {e}^{- j θ} ) ]}{imag [ I \cdot {e}^{jZ 1 ANG} \cdot conj ( {I}_{Pol} \cdot {e}^{jTANG} \cdot {e}^{- j θ} ) ]} \qquad Eq . 5$$

In equation 5, V represents faulted phase voltage, I represents phase loop current or loop current, I_{POL} represents polarizing current or faulted phase loop current for the reactance element characteristic 402, T_{ANG} represents the reactance element characteristic 402 tilt angle setting (e.g., a desired and/or predetermined tilt of the reactance element characteristic 402), and Z_{1ANG} represents a positive sequence line impedance angle between the forward direction reach line 404 and the resistance axis of the impedance plane 400. Moreover, θ represents the angle correction as illustrated in FIG. 4. For example, θ (e.g., an adaptive angle) is defined by equation 6 as a compensation to at least partially compensate the undesired counterclockwise tilt (e.g., undesired changes, deviations, and/or expansions) of the reactance element characteristic 402:

$$θ = [ ∠ {I}_{POL} - ∠ I ] ... if [ ∠ {I}_{POL} - ∠ I ] > 0 \qquad Eq . 6$$

$$else θ = 0$$

As such, the IED 110 may determine the adaptive angle θ to compensate an undesired counterclockwise tilt of the top reactance element which is the top boundary or top reactance element characteristic 402 of the quadrilateral characteristic, and thereby at least partially reduce undesired shifts and/or expansions of the boundaries of the reactance element characteristic 402. That is, the IED 110 may determine an adaptive angle to compensate an undesired counterclockwise tilt of the top reactance element characteristic 402, and thereby at least partially reduce undesired shifts and/or expansions of the boundaries of the quadrilateral characteristic. Accordingly, the IED 110 may have improved reliability and reduced error rate for detecting fault conditions of one or more protected zones and/or performing a protective action such as tripping a circuit breaker compared to other IEDs.

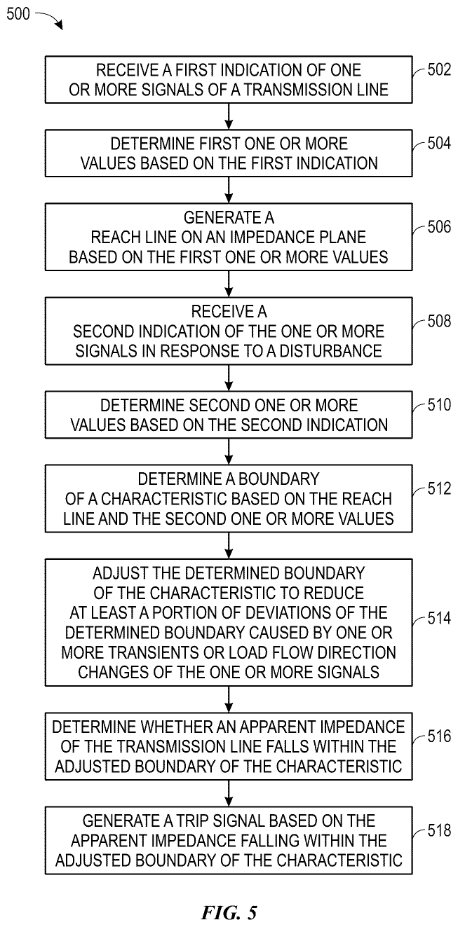

FIG. 5 is a process 500 for generating a characteristic and adjusting boundaries of the characteristic to reduce at least a portion of deviations of a boundary of the characteristic, in accordance with embodiments of the present disclosure. Although the following description of the process 500 is described with reference to the IED 110, it should be noted that the process 500, or at least a portion of the process 500 may be performed by any other viable circuitry. For example, the processing circuitry 140, the signal processing 130, the monitoring and protection circuitry 138, the monitored equipment interface 132, the communication interface 134, and/or the storage media 136 may each perform all or at least a portion of the operations discussed. In some cases, the processing circuitry 140 and the IED 110 may be interchangeably used such that the processing circuitry 140 may perform at least a portion of the operations associated with the IED 110. Additionally, although the following process 500 describes a number of operations that may be performed, it should be noted that the process 500 may be performed in a variety of suitable orders, all of the operations may not be performed, and/or additional operations may be performed.

At block 502, the IED 110 may receive a first indication of one or more signals (e.g., the received signals 122) of the transmission line 114. At block 504, the IED 110 may determine first one or more values based on the first indication. For example, the IED 110 may determine the reach impedance and the loop current associated with a protected zone of a transmission line 114 based on the received signals 122. At block 506, the IED 110 may generate a reach line on an impedance plane based on the first one or more values. For example, the IED 110 may determine a forward direction reach line 306 and/or 404 (or reverse direction reach lines) associated with the protected zone on an impedance plane 300 and/or 400 based on the reach impedance and the loop current.

At block 508, the IED 110 may receive a second indication of the one or more signals in response to a disturbance. At block 510, the IED 110 may determine second one or more values based on the second indication. For example, the IED 110 may determine a faulted phase voltage for the lenticular mho characteristic 304 and/or may determine polarizing current or faulted phase loop current for the reactance element characteristic 402. The IED 110 may determine the polarizing voltage and/or current based on a voltage and/or current of the transmission line 114 during or after the disturbance.

At block 512, the IED 110 may determine a boundary of a characteristic based on the reach line and the second one or more values. For example, the IED 110 may determine the boundary of the characteristic based on the reach line and the faulted phase voltage. At block 514, the IED 110 may adjust the determined boundary of the characteristic to reduce at least a portion of deviations of the determined boundary, for example, caused by one or more transients or load flow direction changes of the one or more signals.

At block 516, the IED 110 may determine whether an apparent impedance of the transmission line 114 falls within the adjusted boundary of the characteristic. The characteristic may correspond to the lenticular mho characteristic 304 and/or the reactance element characteristic 402. Moreover, at block 518, the IED 110 may generate a trip signal based on the apparent impedance falling within the adjusted boundary of the characteristic. For example, the IED 110 may assert a trip signal based on whether the apparent impedance of the transmission line 114 during the disturbance falls within a boundary of the characteristic. Accordingly, the IED 110 may have improved reliability and reduced error rate for detecting fault conditions of one or more protected zones and/or performing a protective action such as tripping a relay compared to other IEDs.

While specific embodiments and applications of the disclosure have been illustrated and described, it is to be understood that the disclosure is not limited to the precise configurations and components disclosed herein. For example, the electric power delivery system 10 described herein may include an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f)

What is claimed is:

1. Tangible, non-transitory, computer-readable media storing instructions that, when executed by processing circuitry, cause the processing circuitry to:
receive a first indication of one or more signals of a transmission line;
determine first one or more values based on the first indication;
generate a reach line of a distance element on an impedance plane based on the first one or more values;
receive a second indication of the one or more signals in response to a disturbance;
determine second one or more values based on the second indication;
determine a boundary of a characteristic of the distance element based on the reach line and the second one or more values;
adjust the determined boundary of the characteristic to reduce at least a portion of deviations of the determined boundary;
determine whether an apparent impedance of the transmission line falls within the adjusted boundary of the characteristic; and
generate a trip signal based on the apparent impedance falling within the adjusted boundary of the characteristic.

2. The tangible, non-transitory, computer-readable media of claim 1, wherein the instructions cause the processing circuitry to receive the first indication of the one or more signals before the disturbance, and receive the second indication of the one or more signals during or after the disturbance.

3. The tangible, non-transitory, computer-readable media of claim 1, wherein the disturbance corresponds to a change in a voltage or a current of the transmission line greater than a threshold.

4. The tangible, non-transitory, computer-readable media of claim 1, wherein the first one or more values comprise a reach impedance and a loop current of the transmission line, wherein the instructions cause the processing circuitry to determine the reach line of the distance element based on the reach impedance and the loop current.

5. The tangible, non-transitory, computer-readable media of claim 4, wherein the instructions cause the processing circuitry to determine a reach point on the impedance plane based on the reach impedance and the loop current, and determine the reach line based on a straight line between a center of the impedance plane and the reach point.

6. The tangible, non-transitory, computer-readable media of claim 1, wherein the second one or more values comprise a faulted phase voltage of the transmission line, wherein the instructions cause the processing circuitry to generate a mho characteristic based on the faulted phase voltage.

7. The tangible, non-transitory, computer-readable media of claim 6, wherein the instructions cause the processing circuitry to adjust the determined boundary of the characteristic by:
determine the boundary of the characteristic based on a first impedance pole, wherein the second one or more values comprises the first impedance pole;
determine a line impedance angle between the reach line and a resistance axis of the impedance plane based on the first one or more values, the second one or more values, or both; and
determine a corrected pole by projecting the first impedance pole onto an extension of the reach line based on the line impedance angle.

8. The tangible, non-transitory, computer-readable media of claim 1, wherein the second one or more values comprise a faulted phase loop current of the transmission line, wherein the instructions cause the processing circuitry to generate a quadrilateral characteristic based on the faulted phase loop current.

9. The tangible, non-transitory, computer-readable media of claim 8, wherein the instructions cause the processing circuitry to adjust the determined boundary of the characteristic by:
determine a top reactance element at a reach point of the reach line based on the second one or more values, wherein the top reactance element is tilted with a first angle in a counterclockwise direction; and
determine a corrected top reactance element by tilting the top reactance element with an adaptive angle in a clockwise direction.

10. The tangible, non-transitory, computer-readable media of claim 1, wherein the instructions cause the processing circuitry to determine the first one or more values and the second one or more values based on a protected zone of the transmission line, wherein the protected zone corresponds to a predetermined length of one or more phases of the transmission line, and the trip signal is indicative of a fault condition being present in the protected zone.

11. The tangible, non-transitory, computer-readable media of claim 1, wherein the transmission line is coupled to at least one electric power source and at least one load of an electric power delivery system.

12. A method comprising:
receiving, by processing circuitry, a first indication of one or more signals of a transmission line;
determining, by the processing circuitry, first one or more values based on the first indication;
generating, by the processing circuitry, a reach line of a distance element on an impedance plane based on the first one or more values;
receiving, by the processing circuitry, a second indication of the one or more signals in response to a disturbance;
determining, by the processing circuitry, second one or more values based on the second indication;
determining, by the processing circuitry, a boundary of a characteristic based on the reach line and the second one or more values;
adjusting, by the processing circuitry, the determined boundary of the characteristic to reduce at least a portion of deviations of the determined boundary caused by one or more transients or load flow direction changes of the one or more signals; and
generating, by the processing circuitry, a trip signal based on an apparent impedance of the transmission line falling within the adjusted boundary of the characteristic.

13. The method of claim 12, comprising receiving, by the processing circuitry, the first indication of the one or more signals before the disturbance, and receive the second indication of the one or more signals during or after the disturbance.

14. The method of claim 12, wherein the disturbance corresponds to a change in a voltage or a current of the transmission line greater than a threshold.

15. The method of claim 12, wherein the first one or more values comprise a reach impedance and a loop current of the transmission line, determining the reach line is based on the reach impedance and the loop current.

16. The method of claim 15, comprising
determining, by the processing circuitry, a reach point on the impedance plane based on the reach impedance and the loop current, and
determining, by the processing circuitry, the reach line based on a straight line between a center of the impedance plane and the reach point.

17. The method of claim 12, wherein the second one or more values comprise a faulted phase voltage of the transmission line.

18. The method of claim 17, comprising generating, by the processing circuitry, a mho characteristic based on the faulted phase voltage.

19. The method of claim 12, wherein the second one or more values comprise a faulted phase loop current of the transmission line.

20. The method of claim 19, comprising generating, by the processing circuitry, a quadrilateral characteristic based on the faulted phase loop current.

21. The method of claim 12, comprising determining, by the processing circuitry, the first one or more values and the second one or more values based on a protected zone of the transmission line, wherein the protected zone corresponds to a predetermined length of one or more phases of the transmission line, and the trip signal is indicative of a fault condition being present in the protected zone.

22. An electric power delivery protection system, comprising:
a data acquisition subsystem coupled to a transmission line of an electric power delivery system to acquire a plurality of current signals and voltage signals from multiple power system phases at a first location of the electric power delivery system;
a distance protection element in communication with the data acquisition subsystem to receive the plurality of current signals and voltage signals and to assert a trip signal for a fault within a first zone of protection by:
calculating an apparent impedance of a fault loop using the plurality of current signals and voltage signals;
comparing the apparent impedance with a distance characteristic, where the distance characteristic is tilt limited;
a protection module in communication with the distance protection element, to:
determine a protection action upon assertion of the distance characteristic; and
effect the determined protective action on the electric power delivery system.
